(19) United States
(12) Patent Application Publication
(10) Pub. No.: US 2008/0092925 A1
(43) Pub. Date: Apr. 24, 2008

(54) REMOVING PHOTORESIST FROM SUBSTRATES BY MEANS OF TREATMENT LIQUID, AND PROCESSING TREATEMENT LIQUID WITH OZONE

(76) Inventors: Sun-young Hong, Yongin-si (KR); Hong-sick Park, Suwon-si (KR); Jong-hyun Choung, Hwaseong-si (KR); Bong-kyun Kim, Incheon (KR); Won-suk Shin, Yongin-si (KR); Byeong-jin Lee, Yongin-si (KR); Tai-bin Im, Incheon (KR)

Correspondence Address: MACPHERSON KWOK CHEN & HEID LLP, 2033 GATEWAY PLACE, SUITE 400, SAN JOSE, CA, 95110, US

(21) Appl. No.: 11/874,013

(22) Filed: Oct. 17, 2007

(30) Foreign Application Priority Data
Oct. 23, 2006 (KR) 10-2006-0103036

(51) Int. Cl. B08B 5/04

(52) U.S. Cl. 134/21; 134/133

(57) ABSTRACT

A substrate is inclined when treatment liquid is ejected onto the substrate to remove photoresist from the substrate. Uniform processing of the substrate with the treatment liquid and collection of the treatment liquid are thus facilitated. Collected treatment liquid is treated with ozone and then reused.

### CROSS REFERENCE TO RELATED APPLICATION

This application claims priority from Korean Patent Application No. 10-2006-0103036 filed on Oct. 23, 2006 in the Korean Intellectual Property Office, the disclosure of which is incorporated herein by reference in its entirety.

### BACKGROUND OF THE INVENTION

1. Field of the Invention

The present invention relates to removing photoresist with treatment liquid and to treatment liquid processing suitable for recycling the treatment liquid.

2. Description of the Related Art

In manufacturing of flat panel displays (FPD) such as liquid crystal displays (LCD), organic light emitting displays (OLED), and plasma displays (PDP), it is common to use photoresist to accomplish photolithographic patterning of various layers on a glass substrate. When the layers have been patterned, the substrate is inserted into a chamber in a horizontal position, and treatment liquid is ejected from nozzles onto the substrate to remove the photoresist. Then the treatment liquid is recovered, filtered, and at least partially reused.

However, in recent years, the display sizes and hence the substrate sizes have increased. Therefore, the glass substrate is sometimes bent to fit in the chamber for photoresist removal. As a result, both uniform application of the treatment liquid to the substrate and the treatment liquid recovery become more complicated.

Further, physical filtering of the treatment liquid is ineffective to remove impurities dissolved in the treatment liquid (as opposed to solid impurities).

Accordingly, there is a need for improved recovery techniques to recover the treatment liquid used in photoresist removal, and for improved uniformity of the photoresist removal from the substrate.

### SUMMARY

This section summarizes some features and advantages of the invention. Other features and advantages are described in subsequent sections. The invention is defined by the appended claims.

Some embodiments of the present invention provide an apparatus that can effectively eject and maintain treatment liquid on a substrate and efficiently recover used treatment liquid. In some embodiments, the recovered treatment liquid can be reused. In some embodiments, the substrate is inclined in the apparatus to allow the treatment treatment to run off the substrate surface and be collected under the substrate. The substrate can be a flat substrate, but this is not necessary. The treatment liquid can be processed with ozone, then reused. Ozone may remove impurities dissolved in the treatment liquid in addition to solid impurities (such as removable with a filter).

Some embodiments include an apparatus for removing photoresist, the apparatus comprising: a chamber comprising a nozzle for ejecting treatment liquid onto a substrate located in the chamber; a transport device for transporting the substrate through the chamber, the substrate being inclined in the chamber; and an ozone reactor for providing ozone to the treatment liquid that was ejected onto the substrate.

Some embodiments include a method for removing photoresist from a substrate, the method comprising: transporting the substrate through a chamber and ejecting treatment liquid which removes the photoresist from the substrate in the chamber; inclining the substrate being transporting in the chamber; and providing ozone to the treatment liquid that was in contact with the substrate.

Other embodiments and variations are described below. The invention is defined by the appended claims.

### BRIEF DESCRIPTION OF THE DRAWINGS

The above and other features and advantages of the present invention will become more apparent by describing in detail preferred embodiments thereof with reference to the attached drawings in which:

FIG. 1 is a schematic cross-sectional view of an apparatus for removing photoresist according to a first embodiment of the present invention;

FIG. 2 is a perspective view of a chamber shown in FIG. 1;

FIG. 3 is a flowchart illustrating the recycling of treatment liquid according to the first embodiment of the present invention;

FIG. 4 is a perspective view of a chamber of an apparatus for removing photoresist according to a second embodiment of the present invention;

FIG. 5 is a perspective view of a chamber of an apparatus for removing photoresist according to a third embodiment of the present invention; and

FIG. 6 is a perspective view of a chamber of an apparatus for removing photoresist according to a fourth embodiment of the present invention.

### DESCRIPTION OF EXEMPLARY EMBODIMENTS

Advantages and features of the present invention and methods of accomplishing the same may be understood more readily by reference to the following detailed description of some embodiments and the accompanying drawings. The present invention may, however, be embodied in many different forms and should not be construed as being limited to the embodiments set forth herein. Rather, these embodiments are described so that this disclosure will be thorough and complete and will fully convey the concept of the invention to those skilled in the art. The present invention is defined by the appended claims. Like reference numerals refer to like elements throughout the specification.

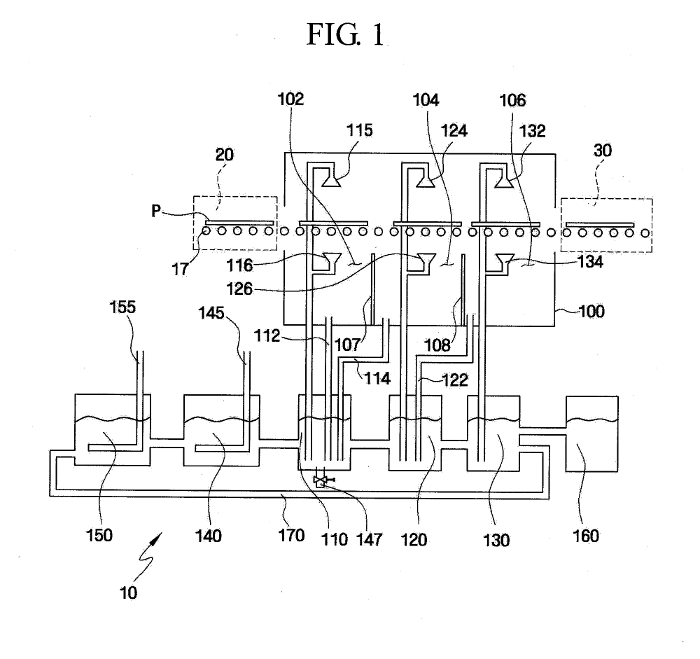

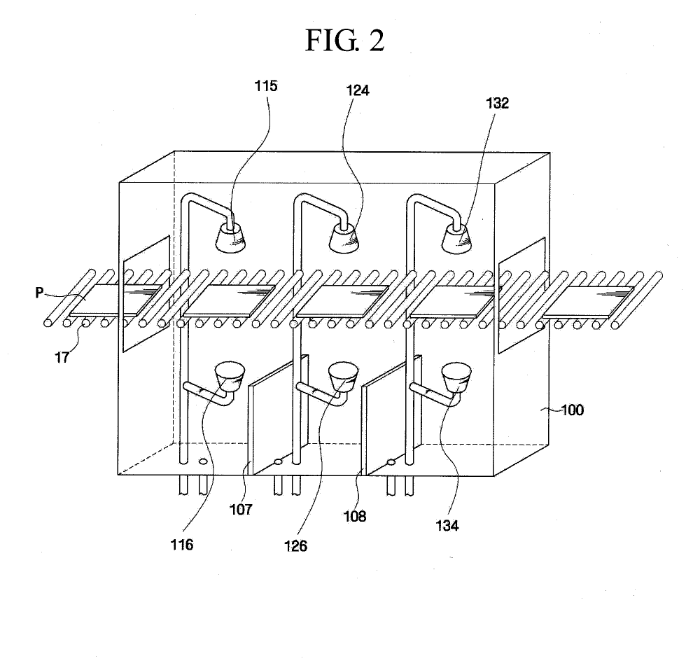

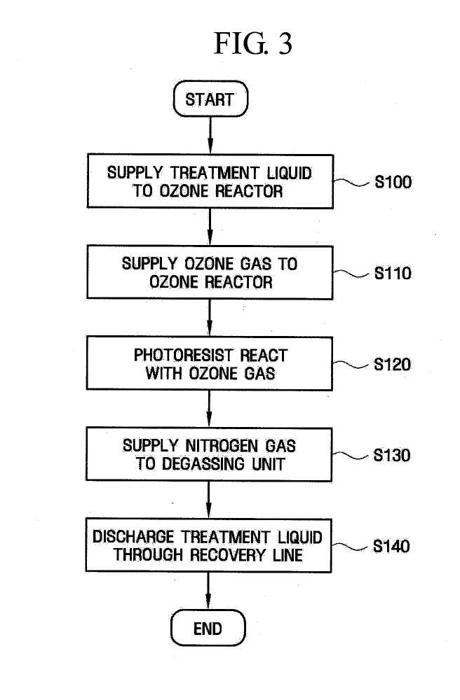

Now a first embodiment of the present invention will be described with reference to FIGS. 1 to 3. FIG. 1 is a schematic cross-sectional view of an apparatus for removing photoresist according to the first embodiment, and FIG. 2 is a perspective view of a chamber shown in FIG. 1. FIG. 3 is a flowchart illustrating the recycling of treatment liquid according to the first embodiment.

The apparatus 10 according of the first embodiment can remove photoresist from a glass or semiconductor substrate of a flat panel display (FPD), such as a liquid crystal display (LCD), an organic light emitting display (OLED), or a plasma display (PDP). The photoresist may have been used in a photolithographic process. The case of the glass substrate is described below for illustration and not to limit the invention to glass.

Referring to FIGS. 1 and 2, the apparatus 10 includes a chamber 100, a roller conveyor 17, a first tank 110, a second tank 120, a third tank 130, an ozone reactor 140, a degassing unit 150, and a fresh liquid tank 160.

When a glass substrate P with photoresist thereon enters the chamber 100, treatment liquid is ejected from nozzles to remove the photoresist in the chamber 100. The chamber 100 is partitioned into a first bath 102, a second bath 104, and a third bath 106 by first and second barrier ribs 107 and 108. The chamber 100 includes conveyor 17 for transporting the glass substrate P, and first to sixth nozzles 115, 116, 124, 126, 132, and 134 from which the treatment liquid is ejected.

The conveyor 17 transports the glass substrate P to the chamber 100, and transports the glass substrate P through the chamber 100 at a predetermined angle of inclination. The substrate P is placed on the conveyor 17 at a loading part 20, and the conveyor transports the glass substrate P through the chamber 100 to an unloading part 30. The glass substrate P is removed from the unloading part 30.

The conveyor 17 is inclined along the entire path from the loading part 20 to the unloading part 30 so that the treatment liquid ejected from the nozzles remains on the glass substrate P for a desired period of time. For this reason, the treatment liquid can be applied uniformly to the entire glass substrate P.

In addition, since the glass substrate P is inclined along the entire path through the chamber 100, different portions of the treatment liquid can be collected separately at different locations along the path of the glass substrate P, and can be processed differently taking into account the concentration of the photoresist residue contained in the treatment liquid collected at different sections of the path.

Conveyor 17 does not have to be roller type. A roller type conveyor advantageously allows easy collection of the treatment liquid. However, other types of conveyors can also be used.

As mentioned above and illustrated in FIG. 2, the conveyor 17 may be inclined by a predetermined angle to allow the glass substrate P to pass through the chamber 100 at the predetermined angle of inclination. The conveyor 17 is inclined throughout its length as if rotated about the axis of motion of the glass substrate P. The glass substrate P is inclined by the same angle as the conveyor 17. No additional equipment is needed to incline the glass substrate. The apparatus structure is advantageously simplified as a result. The loading part 20 or the unloading part 30 can be inclined by the same angle as the conveyor 17, which allows one to eliminate any equipment to change the inclination angle of the glass substrate P between the loading part, the unloading part, and the conveyor inside the chamber 100. In other embodiments, the conveyor 17 is not inclined at the loading and unloading parts, or is inclined at the loading and unloading parts by an angle different from the angle inside the chamber 100.

In other embodiments, conveyor 17 is horizontal. Bedplates (not shown) are disposed on the conveyor to incline the glass substrate. The lower surface of each bedplate is horizontal, and rests on the horizontal conveyor. The upper surface of each bedplate is inclined at a predetermined angle, and the glass substrate is placed on the upper surface. An apparatus with bedplates is described in detail below.

While the glass substrate P passes through the chamber 100, the photoresist is removed (stripped) from the glass substrate P by the treatment liquid. The treatment liquid is thus used as a stripper in this embodiment.

The chamber 100 is partitioned into a first bath 102, a second bath 104, and a third bath 106 by first and second barrier ribs 107 and 108. In some embodiments, the glass substrate P is continuously moved through the baths. In other embodiments, the glass substrate P is stopped in each bath for a predetermined period of time, the treatment liquid is ejected onto the glass substrate P, then the glass substrate P is moved on. The treatment liquid is ejected from nozzles provided in each of the baths, and the treatment liquid ejected onto the glass substrate P runs off the glass substrate to the bottom of each bath.

In more detail, the glass substrate P is delivered into the chamber 100 from the loading part 20, and is first placed into the first bath 102. The first bath 102 is defined by a wall of the chamber 100 and the first barrier rib 107. The first and second nozzles 115 and 116 are provided in the first bath 102 to eject the treatment liquid onto the glass substrate P.

The first nozzle 115 ejects the treatment liquid onto the top surface of the glass substrate P at a right angle or some other predetermined angle as desired to effect photoresist removal.

The second nozzle 116 ejects the treatment liquid from below so as to remove the photoresist flowing down from the top surface of the glass substrate P to the bottom surface of the glass substrate P. In some cases, less treatment liquid is ejected from the second nozzle 116 than from the first nozzle 115.

The treatment liquid ejected from the first and second nozzles 115 and 116 removes a major portion of the photoresist on the glass substrate P, then runs down to the bottom of the first bath 102. There the treatment liquid is collected by a first discharge line 112, which conducts the treatment liquid into the first tank 110.

The treatment liquid stored in the first tank 110 is mixed with the treatment liquid supplied from the second tank 120, and is then again ejected through the first and second nozzles 115 and 116 onto the glass substrate P in the first bath 102.

After a major portion of the photoresist is removed from the glass substrate P in the first bath 102, the glass substrate P is moved to the second bath 104. In the second bath 104, the glass substrate P is exposed to the treatment liquid supplied from the second tank 120 and ejected onto the substrate P through third and fourth nozzles 124 and 126 provided in the second bath 104. The third and fourth nozzles 124 and 126 operate in the same manner as the first and second nozzles 115 and 116. However, since the treatment liquid ejected through the third and fourth nozzles 124 and 126 is supplied from the second tank 120, the treatment liquid contains smaller amounts of impurities (such as photoresist) than the treatment liquid in the first tank 110.

The treatment liquid ejected onto the glass substrate P in the second bath 104 is collected at the bottom of the second bath 104 in a second discharge line 114, which conducts the treatment liquid into the first tank 110.

After the photoresist removal in the second bath 104, the glass substrate P is transported to the third bath 106. In the third bath 106, the glass substrate P is exposed to the treatment liquid supplied from the third tank 130. Fifth and sixth nozzles 132 and 134 are provided in the third bath 106. The treatment liquid supplied from the third tank 130 is ejected through the fifth and sixth nozzles 132 and 134 onto the glass substrate P. The fifth and sixth nozzles 132 and 134 operate in the same manner as the first and second nozzles 115 and 116. However, the treatment liquid supplied from the third tank 130 contains either no impurities or very small amounts of impurities (such as photoresist) compared to the treatment liquid stored in the first and second tanks 110 and 120. This is because the third tank 130 receives fresh treatment liquid from a fresh liquid tank 160 in addition to treatment liquid received from the second tank 120.

The present invention is not limited to the embodiment described above, with the chamber 100 partitioned into three baths by two barrier ribs and with treatment liquid of different impurity concentrations in each bath. The number of baths may be larger or smaller as needed. Further, the present invention is not limited to using the treatment liquid from any particular tank in any particular bath or to any arrangement of tanks storing the treatment liquid. Other schemes for using the treatment liquid and for the arrangement of tanks can be used.

Also, the glass substrate P can continuously move through the baths or can stop in each bath for a predetermined period of time while being wetted with the treatment liquid. Other movement patterns are also possible.

The treatment liquid supplied to the first bath 102 is stored in the first tank 110. Since the treatment liquid ejected onto the glass substrate P is initially collected in the first tank 110, the first tank 110 receives most of the photoresist dissolved in the treatment liquid in the chamber 100. Further, the first tank 110 is connected to the second discharge line 114 to receive the treatment liquid ejected in the second bath 104. Additional treatment liquid is supplied to the first tank 110 from the second tank 120. A portion of the treatment liquid collected in the first tank 110 is re-used in the first bath 102, and another portion is discharged to the ozone reactor 140. The treatment liquid is thus recycled.

Some of the treatment liquid may be unsuitable for recycling, and is discharged outside from the first tank 110 through a waste liquid outlet 147.

The treatment liquid used in the second bath 104 is supplied from the second tank 120. The treatment liquid stored in the second tank 120 is a mixture of the treatment liquid ejected onto the glass substrate P in the third bath 106 and the treatment liquid supplied from the third tank 130. Accordingly, the concentration of photoresist impurities in the second tank 120 is lower than in the first tank 110.

The treatment liquid used in the third bath 106 is supplied from the third tank 130. The treatment liquid stored in the third tank 130 is a mixture of the treatment liquid recycled by the ozone reactor 140 and degassing unit 150 and the treatment liquid supplied from the fresh liquid tank 160. Accordingly, the treatment liquid in the third tank 130 has no or almost no photoresist impurities as compared to the treatment liquid in the first and second tanks 110 and 120.

Even though used treatment liquid contains photoresist impurities, used treatment liquid can still remove photoresist. However, the impurities contaminate the glass substrate P, so the photoresist removal becomes less efficient. The ozone reactor 140 removes the photoresist impurities from the used treatment liquid so that the treatment liquid can be recycled. The photoresist is an organic composition, and is removed by the treatment liquid in a chemical wet process in which the photoresist's organic ingredients are dissolved in the treatment liquid. As described above, used treatment liquid is stored in the first and second tanks 110 and 120. Then a portion of the treatment liquid stored in the first and second tanks 110 and 120 is reused in the first bath 102 or the second bath 104, and a portion of the treatment liquid stored in the first tank 110 is discharged to the ozone reactor 140.

Ozone reactor 140 supplies ozone gas to remove organic materials from the used treatment liquid. Ozone is an oxidizing agent stronger than hydrogen peroxide, and advantageously does not form new contaminants in the treatment liquid.

The ozone reactor 140 includes a reservoir for storing the used treatment liquid and also includes an ozone gas nozzle 145 for supplying ozone gas to the treatment liquid. When the ozone, gas is flown into the treatment liquid containing photoresist impurities, photoresist impurities are decomposed into organic acids. Further, a portion of the photoresist impurities is converted into carbon dioxide (CO₂) and water (H₂O), and is discharged. The organic acids remaining in the treatment liquid after the ozone treatment serve as useful additives which improve the treatment liquid's efficiency in photoresist removal when the treatment liquid is reused.

The degassing unit 150 removes the ozone remaining in the treatment liquid treated with ozone. The ozone is a strong oxidizing agent. For this reason, if the ozone remains in the treatment liquid, the ozone may damage the glass substrate P. The ozone can dissolve organic materials and hence can improve the efficiency of removing the photoresist. However, since the ozone has very strong oxidizing power, the ozone may damage other films on the glass substrate P. It is therefore desirable to remove the ozone from the recycled treatment liquid.

The degassing unit 150 includes a reservoir for storing the treatment liquid which has been treated with ozone in the ozone reactor 140, and also includes a nitrogen gas nozzle 155 for supplying nitrogen gas for removing ozone. When nitrogen gas is supplied to the treatment liquid containing ozone, the nitrogen is dissolved into the treatment liquid and the remaining dissolved ozone (O₃) in the treatment liquid is degassed from the treatment liquid.

The treatment liquid recycled as described above is supplied from the degassin unit 150 to the third tank 130 through a recovery line 170. There the recycled treatment liquid is mixed with the fresh treatment liquid supplied from the fresh liquid tank 160 if needed. The high purity treatment liquid in the third tank 130 is ejected onto the glass substrate P in the third bath 106 for final photoresist removal. Then the glass substrate P is discharged to the unloading part 30.

A process of recycling treatment liquid is illustrated in FIG. 3. First, used treatment liquid is supplied to an ozone reactor (S100). The treatment liquid contains organic materials which are possibly photoresist ingredients. Treatment liquid containing more than some threshold amount of impurities is not supplied to the ozone reactor 140 but is discharged from the first tank 110 through the waste liquid outlet 147.

Ozone gas is supplied to the treatment liquid containing the photoresist impurities (S110). The solubility of ozone is many times higher than of oxygen. Therefore, if ozone is flown to the lower side of the ozone reactor 140, the ozone can easily react with the treatment liquid.

The ozone reacts with the photoresist impurities contained in the treatment liquid (S120) to form carbon dioxide, water, and organic acids. When the treatment liquid is ejected in the chamber 100, the carbon dioxide and water are naturally released from the treatment liquid. However, the organic acids remain in the treatment liquid and serve as additives helping to remove the photoresist.

After S120, nitrogen gas is supplied to the treatment liquid containing ozone (S130). Since the ozone remaining in the recycled treatment liquid has strong oxidizing properties, the ozone may damage the glass substrate P. For this reason, the ozone remaining in the recycled treatment liquid should be removed, and nitrogen is supplied to the treatment liquid to remove the ozone. The solubility of ozone is high at high pressure and low temperature. For this reason, a heater (not shown) is provided to the degassing unit 150 and to adjust the temperature for effective ozone removal.

Subsequently, the treatment liquid is discharged through a recovery line for re-use (S140).

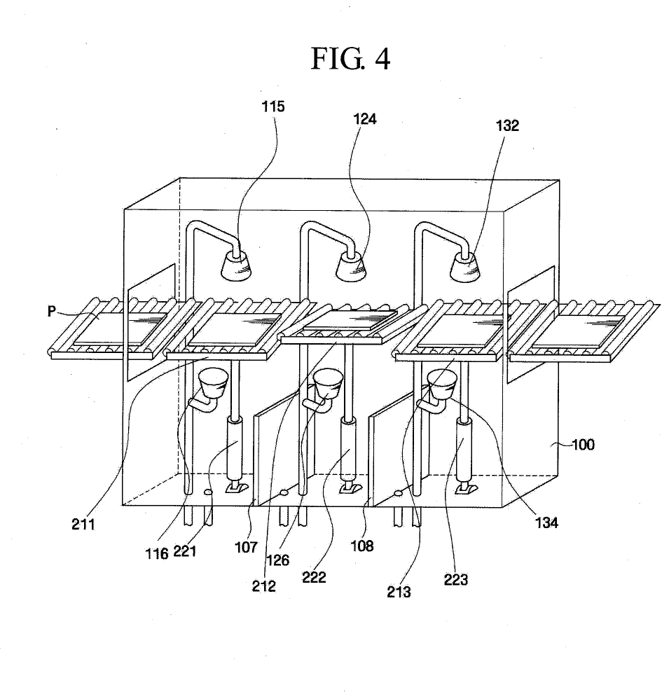

Now an apparatus for removing photoresist according to a second embodiment of the present invention will be described with reference to FIGS. 1 and 4. FIG. 4 is a perspective view of a chamber of the apparatus. For convenience of description, elements having the same functions as in the first embodiment have the same reference numerals, and detailed descriptions thereof will be omitted. The apparatus of the second embodiment has basically the same structure as the apparatus of the first embodiment, except for the following.

In the apparatus 10 of the second embodiment, the conveyor includes conveyor sections 211, 212, 213 in the respective baths, and each conveyor 211, 212, 213 has an independently adjustable inclination angle.

The inclination angle of each of the first to third conveyors 211, 212, and 213 is adjustable with respective first to third actuators 221, 222, and 223 provided in the respective first to third baths 102, 104, and 106. A glass substrate P supplied to the chamber through a loading part 20 is placed on the first conveyor 211 of the first bath 102. Then the first actuator operates to incline the first conveyor 211 by a desired angle. The angle may be chosen based on various factors, including for example the size and the state of the glass substrate P, the thickness of the photoresist, and the concentration of active ingredients and/or impurities in the treatment liquid. The angle of each conveyor can be continuously changed in the process. For example, the first conveyor 211 can be continuously rotated back and forth about the central axis of motion of the glass substrate P, turning by a positive angle relative to the horizontal position, then returning to the horizontal position, then turning by a negative angle with respect to the horizontal position, and so on, to uniformly apply the treatment liquid to the entire surface of the glass substrate P. Similar rotation can be applied to the second and/or third conveyors 212, 213.

Further, as the glass substrate P is transported toward the second conveyor 212 and the third conveyor 213, processing conditions may change including, for example, the concentration of active ingredients and/or impurities in the treatment liquid or the state of the photoresist remaining on the glass substrate P. The angle of each of the first, second and third conveyors 211, 212 and 213 can be adjusted to optimally meet the processing conditions. The glass substrate P can be moved continuously or can be stopped in each of the baths for a predetermined period of time while the treatment liquid is ejected in the bath.

The invention is not limited to any particular inclination angles. In some embodiments, the first conveyor 211 is inclined by a positive angle with respect to a horizontal plane, the second conveyor 212 is inclined by a negative angle with respect to the horizontal plane, and the third conveyor 213 is inclined by a positive angle with respect to the horizontal plane, which makes it possible to uniformly apply the treatment liquid onto the entire glass substrate P and to improve the recovery efficiency of the treatment liquid.

The first to third actuators 221, 222, and 223 are used to adjust the angles of the first to third conveyors 211, 212, and 213. Various motors, air cylinders, or hydraulic cylinders may be used for the first to third actuators 221, 222, and 223. The actuators are not limited to the motors or cylinders.

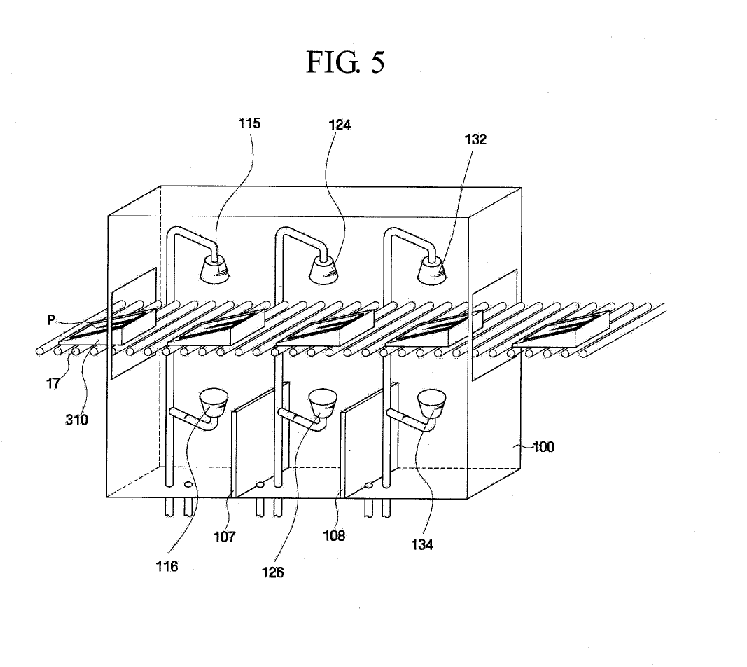

Now an apparatus for removing photoresist according to a third embodiment of the present invention will be described with reference to FIGS. 1 and 5. FIG. 5 is a perspective view illustrating a chamber of the apparatus. For convenience of description, elements having the same functions as those in the drawings of the first embodiment have the same reference numerals, and detailed descriptions thereof will be omitted. The apparatus of the third embodiment has basically the same structure as the apparatus of the first embodiment, except for the following.

The apparatus 10 of the third embodiment can maintain the glass substrate P at a predetermined angle of inclination by using inclined bedplates 310.

The inclined bedplates 310 according to the third embodiment have upper sides inclined down in a direction opposite to the direction of motion of the glass substrate P. The glass substrate P is inclined down in the direction opposite to the direction of motion when the treatment liquid is ejected in the first to third baths 102, 104, and 106. The treatment liquid can thus be uniformly applied to the entire surface of the glass substrate P, and can easily flow down while the glass substrate P is being transported. The treatment liquid thus is collected in each bath and efficiently stored in each tank.

When the above-mentioned inclined bedplates 310 are used, it is possible to obtain the same effect as the conveyors that maintain the glass substrate at a predetermined angle of inclination by using roller conveyors. Further, through holes may be formed in inclined bedplates 310 in the surfaces underlying the glass substrate P, or these surfaces may be formed of meshes, to allow the treatment liquid ejected from the second nozzle 116, the fourth nozzle 126, and the sixth nozzle 134 to reach the lower surface of the glass substrate P.

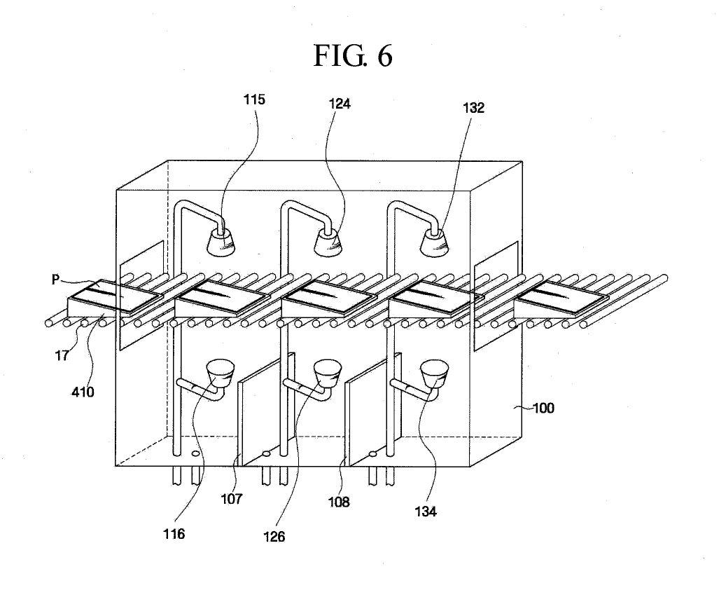

Now an apparatus for removing photoresist according to a fourth embodiment of the present invention will be described with reference to FIGS. 1 and 6. FIG. 6 is a perspective view of a chamber of the apparatus of the fourth embodiment. For convenience of description, elements having the same functions as those in the drawings of the first embodiment have the same reference numerals, and detailed descriptions thereof will be omitted. The apparatus of the fourth embodiment has basically the same structure as the apparatus of the first embodiment, except for the following.

The apparatus 10 of the fourth embodiment can maintain the glass substrate P at a predetermined angle of inclination by using inclined bedplates 410. The apparatus of FIG. 6 is thus similar to the apparatus of FIG. 5 but the inclined bedplates 410 of FIG. 6 are inclined down in the direction of motion of the glass substrate P.

The invention is not limited to the embodiments described above. For example, with reference to FIGS. 5, and 6, bedplates may be inclined down in other directions, i.e. not only in the “backward” direction as in FIG. 5 or “forward” direction as in FIG. 6, but also in a “right” or “left” direction perpendicular to the direction of motion of the glass substrate P, or in some other direction. The direction and angle of the inclination may be chosen based on many factors including, for example, the period of time when the treatment liquid should remain on the glass substrate, the recovery position of the treatment liquid, and the like.

As seen from the above, some embodiments of the present invention include an apparatus for removing photoresist, the apparatus comprising a chamber comprising a nozzle for ejecting treatment liquid onto a substrate located in the chamber. A transport device is provided for transporting the substrate through the chamber. The transport device may include conveyor 17, or conveyors 211, 212, 213, with or without bedplates 310. The substrate is inclined in the chamber. The apparatus also comprises an ozone reactor for providing ozone to the treatment liquid that was ejected onto the substrate.

Some embodiments include a degassing unit for removing ozone from the treatment liquid.

In some embodiments, the transport device comprises at least one conveyor in each of the baths (see e.g. FIG. 4), each conveyor controlling an inclination angle of the substrate to incline the substrate in one of the baths by an angle not obtained in another one of the baths.

When the transport device includes a conveyor and a bedplate for supporting the substrate in the chamber above the conveyor (see e.g. FIGS. 5, 6), the bedplate may have a non-horizontal top surface (to incline the substrate for example). In some embodiments, the bedplate's top surface is inclined down in a direction of motion of the substrate (as in FIG. 6) or in a direction opposite to the direction of motion (as in FIG. 5).

Some embodiments comprise a recovery path for re-using the treatment liquid processed with ozone, the re-using comprising ejecting the treatment liquid to remove the photoresist from the same substrate or from another substrate.

Some embodiments include a method for removing photoresist from a substrate, the method comprising: transporting the substrate through a chamber and ejecting treatment liquid which removes the photoresist from the substrate in the chamber; inclining the substrate being transporting in the chamber; and providing ozone to the treatment liquid that was in contact with the substrate.

It will be apparent to those skilled in the art that other modifications can be made without departing from the scope and spirit of the invention. Therefore, it should be understood that the above embodiments are not limiting but illustrative in all aspects.

What is claimed is:

1. An apparatus for removing photoresist, the apparatus comprising:
a chamber comprising a nozzle for ejecting treatment liquid for stripping the photoresist onto a substrate located in the chamber;
a transport device for transporting the substrate through the chamber, the substrate being inclined in the chamber;
an ozone reactor for providing ozone to the treatment liquid that was ejected onto the substrate and
a degassing unit for removing ozone from the treatment liquid.

2. The apparatus of claim 1, wherein the degassing unit provides nitrogen to the treatment liquid.

3. The apparatus of claim 1, wherein the transport device comprises one or more conveyors.

4. The apparatus of claim 3, wherein the one or more conveyors change an inclination angle of the substrate during the ejection of the treatment liquid.

5. The apparatus of claim 3, further comprising:
actuators for controlling the one or more conveyors to adjust said inclination angle.

6. The apparatus of claim 1, wherein the chamber is partitioned into a plurality of baths by one or more barrier ribs, and the nozzle is one of a plurality of nozzles comprising at least one nozzle in each of the baths.

7. The apparatus of claim 6, wherein the transport device comprises at least one conveyor in each of the baths, each conveyor controlling an inclination angle of the substrate to incline the substrate in one of the baths by an angle not obtained in another one of the baths.

8. The apparatus of claim 6, wherein the substrate is stopped in each bath for at least part of the time when the treatment liquid is being ejected onto the substrate.

9. The apparatus of claim 6, wherein the substrate is moved continuously through the plurality of baths.

10. The apparatus of claim 1 wherein the transport device comprises:
a conveyor; and
a bedplate for supporting the substrate in the chamber above the conveyor, the bedplate having a non-horizontal top surface.

11. The apparatus of claim 10, wherein the conveyor is a roller conveyor.

12. The apparatus of claim 10, wherein the bedplate's top surface is inclined down in a direction of motion of the substrate or in a direction opposite to the direction of motion.

13. The apparatus of claim 1 further comprising a recovery path for re-using the treatment liquid processed with ozone, the re-using comprising ejecting the treatment liquid to remove the photoresist from said substrate or from another substrate.

14. A method for removing photoresist from a substrate, the method comprising:
transporting the substrate through a chamber and ejecting treatment liquid which removes the photoresist from the substrate in the chamber;
inclining the substrate being transporting in the chamber; and
providing ozone to the treatment liquid that was in contact with the substrate.

15. The method of claim 14, further comprising removing ozone from the treatment liquid processed with ozone;
wherein removing ozone comprises supplying nitrogen to the treatment liquid processed with ozone.

16. The method of claim 14, wherein the substrate's inclination angle changes during the ejection of the treatment liquid.

17. The method of claim 14, wherein the chamber is partitioned into a plurality of baths by one or more barrier ribs, and the nozzle is one of a plurality of nozzles comprising at least one nozzle in each of the baths.

18. The method of claim 17, wherein the substrate is inclined in one of the baths by an angle not obtained in another one of the baths.

19. The method of claim 17, wherein the substrate is stopped in each bath for at least part of the time when the treatment liquid is being ejected onto the substrate.

20. The method of claim 17, wherein the substrate is moved continuously through the plurality of baths.
